(19) United States
(12) Patent Application Publication
(10) Pub. No.: US 2026/0330172 A1
(43) Pub. Date: Oct. 22, 2026

(54) MULTI-VERSION CONTACTLESS AUTHENTICATION CARD

(71) Applicant: Capital One Services, LLC, McLean, VA (US)

(72) Inventors: Kevin Osborn, Newton Highlands, MA (US); Narmeen Rahman, Brooklyn, NY (US)

(21) Appl. No.: 19/180,991

(22) Filed: Apr. 16, 2025

(51) Int. Cl. G06K 19/073; G06K 19/07; H04L 9/32

(52) U.S. Cl. CPC G06K 19/073; G06K 19/0723; H04L 9/3228; H04L 9/3242

(57) ABSTRACT

The disclosed system and method are directed to providing multi version application support on a contactless card. A described solution involves storage of applet code corresponding to different versions of an applet executing on the contactless card. The alteration of applet’s operation in accordance with different applet version may then be implemented on the contactless card by updating control and operational data values in correspondence to a desired applet version. Version-specific operational and control data may be provided to the applet at run-time via a secure write command. A subsequent read command may then retrieve a output message in accordance with the applet operation indicated by the updated control and operational data value.

### FIELD OF THE DISCLOSURE

The present disclosure is generally related to operation of contactless card and more specifically to implementation of a multi-version contactless card.

### BACKGROUND

Contactless card products have become ubiquitous and have fundamentally changed the manner in which financial transactions are conducted in society today. One important aspect of such contactless cards involves authentication functionality, including the generation of unique authentication codes, that can be implemented by one or more applets or other software applications stored and configured on the contactless card.

Generally, the operations of such applets are fixed based on specific applet code and internal data written to the card. This often occurs during a personalization phase of the card, prior to activation of the card by a user. Therefore, active modifications of an applet response may only be implemented by re-issuing the card with an updated version of the applet code. Accordingly, one important limitation associated with operations of such contactless card applets is lack of versatility with respect to their active phase operations. As such, there is need for enabling active phase operational modifications of such contactless card applets.

These and other deficiencies exist. As such, there is need for an improved system and process for enabling multi-version applet operations and mode switching during the active life cycle of contactless card applets.

### SUMMARY OF THE DISCLOSURE

In some aspects, the techniques described herein relate to a method for providing multi version application support on a contactless card, the method comprising: providing, on the contactless card storing a first applet associated with a first applet version, operational code associated with a plurality of applet versions; generating, by a first device in communication with the contactless card, a write data command comprising one or more control data values, a nonce and a first message authentication code (MAC), the write command being transmitted to the first applet; updating, upon validation of the first MAC by the first applet, one or more control indicators in a memory of the contactless card based on the one or more control data values provided in the write command, wherein the one or more updated control indicators cause the first applet to operate in accordance with a second applet version; and in response to receiving a read data command, generating, by the first applet, a response message in accordance with the second applet version.

In some aspects, the techniques described herein relate to a system for enabling applet version switching during active life cycle of a contactless card, the system comprising: a contactless card having a processor and a memory storing a first applet associated with a first applet version, the memory may further store operational code associated with a plurality of applet versions, the contactless card may also include an NFC interface for wireless communication with a client device. The client device may be configured to: generate a write data command comprising one or more control data values for setting one or more control indicator values in the memory of the contactless card, and a first message authentication code (MAC); transmit the write data command and the first MAC, via the NFC interface, to the first applet stored on the contactless card; wherein upon receiving the write data command, the contactless card is configured to: Validate the first MAC; update, by the first applet, one or more control indicators values in the memory of the contactless card based on the one or more control data values provided in the write command, wherein the one or more updated control indicators cause the first applet to operate in accordance with a second applet version.

In some aspects, the techniques described herein relate to a computer-readable non-transitory medium including computer-executable instructions that, when executed by at least one processor, perform procedures including the steps of: providing, on the contactless card storing a first applet associated with a first applet version, operational code associated with a plurality of applet versions; generating, by a first device in communication with the contactless card, a write data command comprising one or more control data values, a nonce and a first message authentication code (MAC), the write command being transmitted to the first applet; updating, upon validation of the first MAC by the first applet, one or more control indicators in a memory of the contactless card based on the one or more control data values provided in the write command, wherein the one or more updated control indicators cause the first applet to operate in accordance with a second applet version; and in response to receiving a read data command, generating, by the first applet, a response message in accordance with the second applet version.

### BRIEF DESCRIPTION OF THE DRAWINGS

FIG. 1 illustrates a system implementation according to an example embodiment.

FIG. 2 illustrates a process for secure updating of control parameters and operational data values for enabling version-specific operation of a multi-mode applet stored on a contactless card according to an example embodiment.

FIG. 3 illustrates a write NDEF record according to an example embodiment.

FIG. 4 illustrated a read NDEF record according to an example embodiment.

FIG. 5 illustrates an exemplary process flow diagram for a command-based mode switching between different versions of a multi-mode applet stored on a contactless card according to an example embodiment.

FIG. 6 illustrates an exemplary switchboard system implementation according to an example embodiment.

FIG. 7 illustrates a block diagram of an exemplary system according to an example embodiment.

### DETAILED DESCRIPTION

The following description of exemplary embodiments provides non-limiting representative examples referencing numerals to particularly describe features and teachings of different aspects of the invention. The embodiments described should be recognized as capable of implementation separately, or in combination, with other embodiments from the description of the embodiments. A person of ordinary skill in the art reviewing the description of embodiments should be able to learn and understand the different described aspects of the invention. The description of embodiments should facilitate understanding of the invention to such an extent that other implementations, not specifically covered but within the knowledge of a person of skill in the art having read the description of embodiments, would be understood to be consistent with an application of the invention.

Furthermore, the described features, advantages, and characteristics of the exemplary embodiments may be combined in any suitable manner. One skilled in the relevant art will recognize that the embodiments may be practiced without one or more of the specific features or advantages of an embodiment. In other instances, additional features and advantages may be recognized in certain embodiments that may not be present in all embodiments. One skilled in the relevant art will understand that the described features, advantages, and characteristics of any embodiment can be interchangeably combined with the features, advantages, and characteristics of any other embodiment.

One embodiment of the present application describes a command-based method for altering a configuration of a card applet in accordance with various applet versions at run time (e.g., during active operational cycle of a contactless card. Accordingly, the described method enables multi-version application support on a contactless card. This alternation may correspond to various data parameters stored on the contactless card during manufacturing/personalization phase of the card as well as session-specific data actively written to the contactless card at run-time. As such, one aspect of the present disclosure describes a method for run-time mode switching of the authentication protocol enacted by the contactless card 101 (e.g., applet 103 executing on the contactless card 101). The mode switching operation may involve providing, on the contactless card (e.g., a contactless card running a first applet associated with a first applet version) operational code associated with a plurality of applet versions. The run-time mode switching process may be facilitated via control data written to the contactless card via a near-field communication (NFC) tag incorporated onto the contactless card. In addition to the control data for altering operation of a card applet, input operational data that may be required by the altered operation may also be written to the contactless card via the NFC tag. For example, by a client device with NFC connectivity to the contactless card. In some embodiments, control and input operational data associated with altered operation of the contactless card may also be written to the contactless card by a corresponding server that can communicate with the contactless card via the client device. Accordingly, a client device with NFC connectivity to the contactless card, or a server with network connectivity to the client device, may generate a write data command comprising one or more control data values for updating one or more control indicators in the memory of the contactless card. In addition to the one or more control data values for altering operation of the applet, the write command may further include a session nonce, generated by the client device, or a sever communicatively coupled with the client device. The nonce may be required for computation of the applet response message as determined by the updated control indicator values. For example, the applet response message may correspond to a one-time password (OTP) cryptogram generated, in response to receiving a read data command, using the nonce and a first set of data records stored on the memory of the contactless card. In some embodiment, first set of data records, associated with operation of the first applet according to the second applet version, may be a superset of a second set of data records associated with operation of the first applet according to the first applet version.

Considering that a write operation is a secure the write command may be provided with a digital signature, such as a first command message authentication code (MAC) that may be generated based on the nonce and the control data values and transmitted along with the write command to the contactless card applet (e.g., first applet associated with a first applet version). In accordance with some embodiment of the present disclosure, control and operational data parameters required for altering an operation of a card applet in accordance with various applet versions (e.g., changing an output response of a first contactless card applet from a first applet version to a second applet version) may be protected against arbitrary write access. Accordingly, in some embodiment, the write command may be encrypted by the client device upon transmission and validated by the contactless card upon reception. The encryption and decryption/validation of the write command packet by using a secret key (e.g., a first key) that is distinct from the cryptographic keys used for generating and encrypting an applet’s OTP response generated in response to a read request.

The write command (e.g., for writing onto the contactless card control and operational data parameters required for altering an operation of a card applet in accordance with various applet versions) may be operative to change an output response of a first contactless card applet from a first applet version to a second applet version. A subsequent NFC read request/command may then cause the first applet to generate an OTP cryptogram in accordance with the second applet version (which may be retrieved across a secure session established between the card and the command issuing entity). In some embodiments, the write command and the read command may be received and processed by the contactless card within a same NFC session established between the contactless card and the client device (e.g., during a single actuation of the contactless card). However, in some embodiments the write command and the read command may be transmitted to the contactless card via distinct NFC sessions established between the contactless card and the client device. This scenario may be applicable when the client device corresponds to a user computing device that perform write and read operations in separate NFC sessions (e.g., when the NFC connection is established through a browser application with a WebNFC browser extension. In such scenarios the nonce, upon being received along with the write command, may be written into a non-volatile memory of the contactless card based on a value of the one or more updated control indicators.

In some embodiments, the write command for setting control values associated with version-specific applet operation and the read commands for retrieving a version-specific applet response may be encapsulated into an NFC Data Exchange Format (NDEF) message prior to being transmitted to the contactless card.

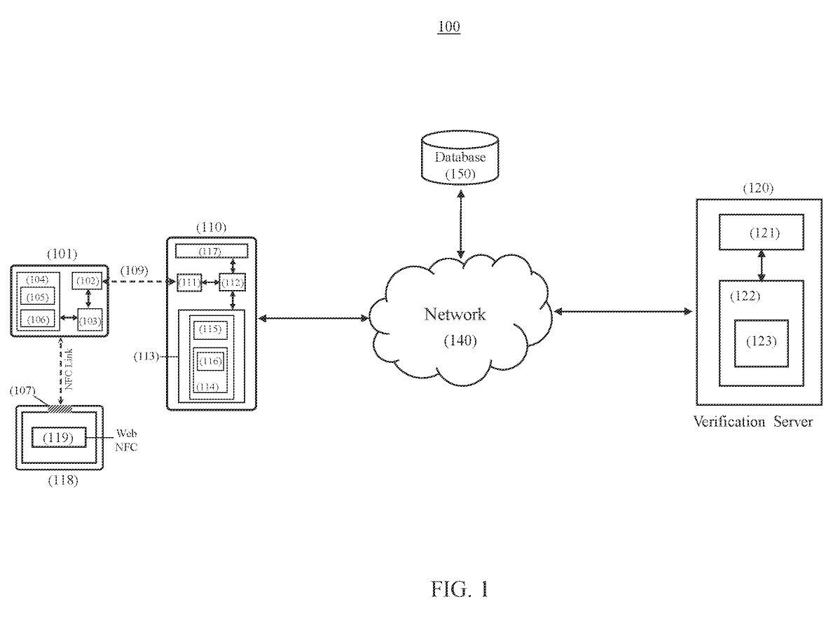

FIG. 1 illustrates a system 100 according to an example embodiment. The system 100 may comprise a contactless card 101, a user communication device 110 and/or computing device 118, a server 120, a network 140 and a database 150. Although FIG. 1 illustrates single instances of components of system 100, system 100 may include any number of components. Example 100, of FIG. 1, illustrates an exemplary representation of a contactless card 101 configured with an NFC interface/tag 102 and a user mobile device 110 configured with an NFC reader unit 111. The contactless card may comprise an integrated processor 103 and memory 104 that may store, for example, user identifying and/or authenticating information as near field communication (NFC) transmittable data (e.g., NFC Data Exchange Format (NDEF)). The integrated memory 104 may also store one or more applets 105 that may be communicatively coupled to one or more applications 114 running on the user mobile device 110 (e.g. NFC reading application and/or API 115 for facilitating one or more wireless reads and writes of the contactless card 101 and/or a WebNFC-based browser 116). Applet 105 may correspond to an NDEF applet storing one or more NDEF records which may be updated via an NDEF write command transmitted from the mobile communication device 110 and/or read from the contactless card via an NDEF read command transmitted from the mobile communication device 110.

The card-integrated memory may further store one or more data records 106 associated with the one or more applets 105. The card-integrated memory 104 may also include an application transaction counter (not shown) to keep track of a proper sequence of read and/or write transaction associated with the contactless card 101. The contactless card 101 may further comprise a Near Field Communication (NFC) interface/tag 102 to facilitate NFC communication with an NFC reader (e.g., reader unit 111 of the user mobile device 110 via NFC link 109.) A contactless transaction (e.g., a read and/or write operation directed at the contactless card 101) may be facilitated by the reader unit 111 of the mobile user device 110, by bringing the contactless card within an NFC range of the mobile device (e.g., by tapping the contactless card on a reader of the user mobile device).

In reference to FIG. 1, the user communication device 110, may include one or more processors 112 (e.g., one or more microprocessors), coupled to memory 113, which may be, for example, random access memory (RAM), read-only memory (ROM), programmable read-only memory (PROM), erasable programmable read-only memory (EPROM), and/or electrically erasable programmable read-only memory (EEPROM), and the user device 110 may include one or more of these memories. A read-only memory may be factory programmable as read-only or one-time programmable. One-time programmability provides the opportunity to write once then read many times. A write-once read-multiple memory may be programmed at a point in time after the memory chip has left the factory. Once the memory is programmed, it may not be rewritten, but it may be read many times. A read/write memory may be programmed and re-programed many times after leaving the factory. It may also be read many times.

Memory 113 may include one or more applications 114, for facilitating NFC-based exchange of data with an external source within an NFC field of the mobile device. Accordingly the mobile device 110 may be configured for wireless communication with the contactless card 101 via a short-range wireless connection (e.g., NFC), and network communication, via a network 140 with one or more remote servers (e.g., server 120). The processor 112 may be a processor, a microprocessor, or other processor, and the user communication device 110 may include one or more of these processors. The processor 112 may include processing circuitry, which may contain additional components, including additional processors, memories, error and parity/CRC checkers, data encoders, anti-collision algorithms, controllers, command decoders, security primitives and tamper-proofing hardware, as necessary to perform the functions described herein.

The user communication device 110 may further include one or more input/output (I/O) devices 117 for capturing user inputs and displaying one or more information records and/or notification messages to the user. For example, I/O devices 117 may include at least one display and input device. The display may be any type of device for presenting visual information such as a computer monitor, a flat panel display, and a mobile device screen, including liquid crystal displays, light-emitting diode displays, plasma panels, and cathode ray tube displays. The input devices may include any device for entering information into the user (mobile) device that is available and supported by the device, such as a touch-screen, keyboard, mouse, cursor-control device, touch-screen, microphone, digital camera, video recorder or camcorder.

I/O devices 117, associated with the user device 110, may include an electronic wireless interface (e.g., reader/writer unit 111) for writing data to and capturing data from the contactless card 101 via one or more short range communications protocols such as near field communication (NFC). The user device 110 may be configured to transmit one or more read/write instruction to the contactless card 101, via NFC link 109. The user device 110 may be a network-enabled computer device, with a network communication interface. Exemplary network-enabled computer devices include, without limitation, a server, a network appliance, a personal computer, a workstation, a phone, a handheld personal computer, a personal digital assistant, a contactless card, a thin client, a fat client, an Internet browser, a mobile device, a kiosk, or other network-enabled computing or communications devices. For example, network-enabled computer devices may include an iPhone, iPod, iPad from Apple® or any other mobile device running Apple’s iOS® operating system, any device running Microsoft’s Windows® Mobile operating system, any device running Google’s Android® operating system, and/or any other smartphone, tablet, or like wearable mobile device. It is further understood that the user (mobile) device may be of any type of device that supports the communication and display of data and user input. The present disclosure is not limited to a specific number of user devices, and it is understood that the system 100 may include a single client device or multiple client devices.

Referring back to FIG. 1, the memory 113, of the user communication device 110, may be configured to store one or more software applications, such as applications 114, and other data, such as user’s private data and financial account information. Applications 114 may comprise for example, an NFC application and/or API 115 for direct communication of data bytes with the contactless card 101. In some embodiments, applications 114 may further operate as an intermediary application for facilitating communication between server 120 (e.g., process 123) and contactless card 101 (e.g., applet 105). Applications 114, stored on user communication device 110, may further comprise a mobile browser 116 with a browser extension (e.g., WebNFC) to enable implementation of communication between the server 120 and contactless card 101 via generic NFC protocols such as a WebNFC API. The WebNFC-enabled mobile browser 116 allows a website (loaded on the user device such as the mobile device 110 and/or computing device 118) to communicate (read and/or write) with an NFC tag (e.g., NFC interface/tag 102 of contactless card 101) through the device’s NFC reader (e.g., short-range wireless communication unit 111 of the mobile device 110 and/or the wireless communication unit 107 of the computing device 118), using NDEF messaging. Therefore, as described with respect to the example 100 of FIG. 1, the user device running the webNFC-based browser for communication of server-generated data to a user contactless card 101, may correspond to a user mobile device 110 (having short-range wireless communication unit 111) and/or a user computing device 118 (such as a desktop, laptop, and/or tablet) equipped with a wireless communication unit 107. This allows the described operation to take place without a specialized client application on the user device.

One aspect of the described process as facilitated by the system configuration 100 may correspond to the distributed transmission of diagnostic read/write codes, by server 120, to the reader applications (e.g., mobile application 115 and/or webNFC enabled browser applications 116 and/or 119 stored on mobile device 110 and computing device 118, respectively) installed across a distributed population of user devices. The diagnostic read/write codes, generated, for example, by server 120, may be operative to retrieve, for analysis, diagnostic information, such as a version number data corresponding to one or more applets (e.g., applet files 105), stored on the contactless card 101.

The server 120 may be a network-enabled computer device. Exemplary network-enabled computer devices include, without limitation, a server, a network appliance, a personal computer, a workstation, a phone, a handheld personal computer, a personal digital assistant, a contactless card, a thin client, a fat client, an Internet browser, a mobile device, a kiosk, an automatic teller machine (ATM), or other a computer device or communications device. For example, network-enabled computer devices may include an iPhone, iPod, iPad from Apple® or any other mobile device running Apple’s iOS® operating system, any device running Microsoft’s Windows® Mobile operating system, any device running Google’s Android® operating system, and/or any other smartphone, tablet, or like wearable mobile device.

The server 120 may include a processor 121, a memory 122, and an application 123. The processor 121 may be a processor, a microprocessor, or other processor, and the server 120 may include one or more of these processors. The processor 121 may include processing circuitry, which may contain additional components, including additional processors, memories, error and parity/CRC checkers, data encoders, anti-collision algorithms, controllers, command decoders, security primitives and tamper-proofing hardware, as necessary to perform the functions described herein.

The processor 121 may be coupled to the memory 122. The memory 122 may be a read-only memory, write-once read-multiple memory or read/write memory, e.g., RAM, ROM, and EEPROM, and the server 120 may include one or more of these memories. A read-only memory may be factory programmable as read-only or one-time programmable. One-time programmability provides the opportunity to write once then read many times. A write-once read-multiple memory may be programmed at a point in time after the memory chip has left the factory. Once the memory is programmed, it may not be rewritten, but it may be read many times. A read/write memory may be programmed and re-programed many times after leaving the factory. It may also be read many times. The memory 122 may be configured to store one or more software applications, such as the application 123, and other data, such as user’s private data and financial account information.

The application 123 may comprise one or more software applications comprising instructions for execution on the server 120. In some examples, the server 120 may execute one or more applications, such as software applications, that enable, for example, network communications with one or more components of the system 100, transmit and/or receive data, and perform the functions described herein. Upon execution by the processor 121, the application 123 may provide the functions described in this specification, specifically to execute and perform the steps and functions in the process flows described below. Such processes may be implemented in software, such as software modules, for execution by computers or other machines. The application 123 may provide GUIs through which a user may view and interact with other components and devices within the system 100. The GUIs may be formatted, for example, as web pages in HyperText Markup Language (HTML), Extensible Markup Language (XML) or in any other suitable form for presentation on a display device depending upon applications used by users to interact with the system 100.

The server 120 may further include a display and input devices (not shown). The display may be any type of device for presenting visual information such as a computer monitor, a flat panel display, and a mobile device screen, including liquid crystal displays, light-emitting diode displays, plasma panels, and cathode ray tube displays. The input devices may include any device for entering information into the server 120 that can be available and supported by the server 120, such as a touch-screen, keyboard, mouse, cursor-control device, touch-screen, microphone, digital camera, video recorder or camcorder. These devices may be used to enter information and interact with the software and other devices described herein.

System 100 may include one or more networks 140. In some examples, the network 140 may be one or more of a wireless network, a wired network or any combination of wireless network and wired network, and may be configured to connect the user devices (e.g., mobile device 110 and/or computing device 118), the server 120 and the database 150. For example, the network 140 may include one or more of a fiber optics network, a passive optical network, a cable network, an Internet network, a satellite network, a wireless local area network (LAN), a Global System for Mobile Communication, a Personal Communication Service, a Personal Area Network, Wireless Application Protocol, Multimedia Messaging Service, Enhanced Messaging Service, Short Message Service, Time Division Multiplexing based systems, Code Division Multiple Access based systems, D-AMPS, Wi-Fi, Fixed Wireless Data, IEEE 802.11b, 802.15.1, 802.11n and 802.11g, Bluetooth, NFC, Radio Frequency Identification (RFID), Wi-Fi, and/or the like.

In addition, the network 140 may include, without limitation, telephone lines, fiber optics, IEEE Ethernet 902.3, a wide area network, a wireless personal area network, a LAN, or a global network such as the Internet. In addition, the network 140 may support an Internet network, a wireless communication network, a cellular network, or the like, or any combination thereof. The network 140 may further include one network, or any number of the exemplary types of networks mentioned above, operating as a stand-alone network or in cooperation with each other. The network 140 may utilize one or more protocols of one or more network elements to which they are communicatively coupled. The network 140 may translate to or from other protocols to one or more protocols of network devices. Although the network 140 is depicted as a single network, it should be appreciated that according to one or more examples, the network 140 may comprise a plurality of interconnected networks, such as, for example, the Internet, a service provider's network, a cable television network, corporate networks, such as credit card association networks, and home networks. The network 140 may further comprise, or be configured to create, one or more front channels, which may be publicly accessible and through which communications may be observable, and one or more secured back channels, which may not be publicly accessible and through which communications may not be observable.

System 100 may include a database 150. The database 150 may be one or more databases configured to store data, including without limitation, private data of users, financial accounts of users, identities of users, transactions of users, and certified and uncertified documents. The database 150 may comprise a relational database, a non-relational database, or other database implementations, and any combination thereof, including a plurality of relational databases and non-relational databases. In some examples, the database 150 may comprise a desktop database, a mobile database, or an in-memory database. Further, the database 150 may be hosted internally by the server 120 or may be hosted externally of the server 120, such as by a server, by a cloud-based platform, or in any storage device that is in data communication with the server 120.

In some examples, exemplary procedures in accordance with the present disclosure described herein can be performed by a processing arrangement and/or a computing arrangement (e.g., a computer hardware arrangement). Such processing/computing arrangement can be, for example entirely or a part of, or include, but not limited to, a computer/processor that can include, for example one or more microprocessors, and use instructions stored on a non-transitory computer-accessible medium (e.g., RAM, ROM, hard drive, or other storage device). For example, a computer-accessible medium can be part of the memory of the contactless card 101, the user device 110, the server 120, the network 140, and the database 150 or other computer hardware arrangement.

In some examples, a computer-accessible medium (e.g., as described herein, a storage device such as a hard disk, floppy disk, memory stick, CD-ROM, RAM, ROM, etc., or a collection thereof) can be provided (e.g., in communication with the processing arrangement). The computer-accessible medium can contain executable instructions thereon. Additionally or alternatively, a storage arrangement can be provided separately from the computer-accessible medium, which can provide the instructions to the processing arrangement so as to configure the processing arrangement to execute certain exemplary procedures, processes, and methods, as described herein above, for example.

In general, a read command, received by an applet 210 stored on an authentication contactless card (not shown), may be associated with generation of a one-time password (OTP) cryptogram computed in accordance with a first version of the applet 210 (e.g., an initial version of the applet running on the card). With reference to example 200, this may correspond to a default cryptogram computation routine 216, associated with a first applet version of the applet 210. An encrypted OTP, generated as defined by the applet version, may then be retrieved/read by a read command.

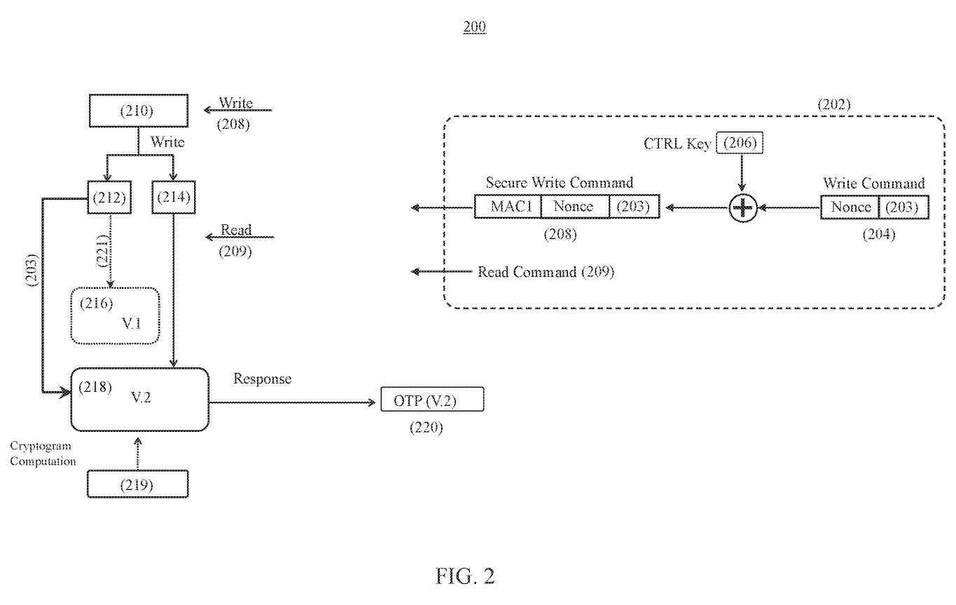

Referring back to FIG. 2, an exemplary command generation process for generation of an encrypted write command associated is shown by the overview process flow 202. The command generation process may be performed by one or more server-side and/or client device side operations (e.g., the encrypted write command 206, may be generated by the server in communication with the contactless card via intermediary client device, or by the client device in NFC connectivity with the contactless card). The encrypted write command associated 208, may be used, for example, to securely set one or more operational parameters associated with operation of the applet 210 stored on the contactless card (not shown). In some embodiments, operational parameters associated with a contactless card applet (e.g., applet 220) may correspond to one or more control indicator data 212 and a nonce data record 214 that may be associated with specifying operation of applet 210 stored on the contactless card.

Referring back to example 200, the exemplary write/read command generation process 202, may generates a write command 204. The write command 204 may be operative to alter operation of the contactless card (e.g., by setting values of operational parameter stored on the contactless card) and as such may require a security feature. Accordingly, with reference to the exemplary write command generation process 202, a digital signature (e.g., MAC1) may be computed for the write command 204. The digital signature computed for the write command packet may correspond to an update message authentication code (MAC). In some embodiment the update MAC (e.g., MAC 1) is computed over the values of the nonce and the control data 203, provided in the write packet, using a secret key (e.g., key 206).

A process flow initiated by contactless card applet 210, in response to receiving and validating the encrypted write command 208 is illustrated in FIG. 2. Responsive to receiving the write command message and validating the associated MAC, control data values, included in the write message may be allowed to update/change control setting of the applet 210. The secure write command 208, maybe operative to modify a response of the contactless card applet 210 to a subsequent read message 209, such that an applet response in accordance with second applet version is returned (e.g., OTP cryptogram 220).

In accordance with some embodiments, the contactless card memory, in addition to storing applet 210 operating, for example, according to a first applet version, may also store operational code for supporting multiple versions of the applet (e.g., different applet versions may correspond to different ways of computing an OTP cryptogram associated with a read response of the applet 210 or different ways of routing encrypted data through a distributed network). As described above, data written onto the contactless card, upon receipt and validation of the secure write command 208, may provide control settings 212 to modify operation of the applet in accordance with a desired version. The secure write command 208 may further provide operational data values (e.g., randomly generated nonce value 214) for inclusion in the computation of an OTP response based on the desired applet version. This is further illustrated with respect to the exemplary operation of applet 210 in response to receiving and validating of the secure write command 208.

Referring back to example 200 of FIG. 2, control data values 221 may initiate OTP cryptogram computation 216 (which may correspond to a fist applet version of applet 210) for generating an applet read response. As further shown in example 200, control data values 203 may initiate OTP cryptogram computation 218 which may correspond to a second applet version of applet 210. Accordingly, control data values provided by the write command 208, (e.g., for updating the control indicator data 212) may direct operations of the applet 210 based on the desired applet version. For example, OTP cryptogram computation 216 associated with a first version of the applet 210 may be associated with a faster execution time but a less secure OTP cryptogram relative to OTP cryptogram computation 218 associated with a second version of applet 210. Therefore, depending on application requirements and various use cases, different applet versions may be executed by providing appropriate values for the control indicator data 212. In example 200, illustrated in FIG. 2, updated control data values 203, provided by the secure write command 208, initiate OTP cryptogram computation 218. The computation 218 may be specified as a function of the nonce, provided by the wrote command, and first set of internally stored data records 219 as directed by a corresponding operational code for the second applet version pf applet 210. The generated applet response, corresponding to OTP cryptogram 220 computed in accordance with second applet version, may then be retrieved via the subsequent read command 209.

In some cases, the response message is generated based on control and operational data provided in a write command, and retrieved, via a subsequent read command received by the contactless card applet in the same NFC session. In some cases, involving NFC connectivity implemented via a WebNFC browser application executing on a client computing device, write and read operations may be performed in separated NFC sessions. With respect to the latter, the nonce data may be made to persist across separate NFC sessions by including control data values, in the write command, for writing on the nonce into a non-volatile memory of the contactless card. In some embodiments the write command packet may be encapsulated into an NDEF message. The NDEF encapsulated write and/or read message may then be received and processed by an NDEF applet (e.g., applet 210) stored on the contactless card.

In some embodiment, the write command may be transmitted as an stand-alone/single command packet. In some embodiments, the write command may be transmitted as part of a modified (multi-component) command packet such that the command data packet comprises a write instruction for setting the control indicator values (e.g., to direct the operation of the applet according to the desired version), and operational data values (e.g., a nonce) required for execution of card operation in accordance with the desired version. For example, with reference to example 200, the read command 209 may correspond to a modified OTP request which involves writing of data 203 onto the card for altering configuration of the applet 210 in accordance with the second applet version, prior to retrieving the applet’s OTP response 220.

As described above, the write command generation process 202 may be carried out by mobile application, running on a client device, with NFC connectivity to the applet 210. However, in some embodiment, the write command generation process 202 may correspond to a server-side process wherein the server is communicatively coupled to the contactless card applet 210 via the client device application having an NFC connectivity to the applet 210. Accordingly, one application of the described system and process may involve transmission of coded instructions (e.g., by a server-side process) to a distributed set of user mobile devices running a corresponding mobile application. The coded instructions may be generated as NDEF encapsulated data command for modifying internal settings of contactless card applets associated with a plurality of contactless card. As such, one operational aspect associated with the described system and method may correspond to server-initiated distributed writing of control and operational data onto a plurality of contactless card via corresponding plurality of mobile client devices.

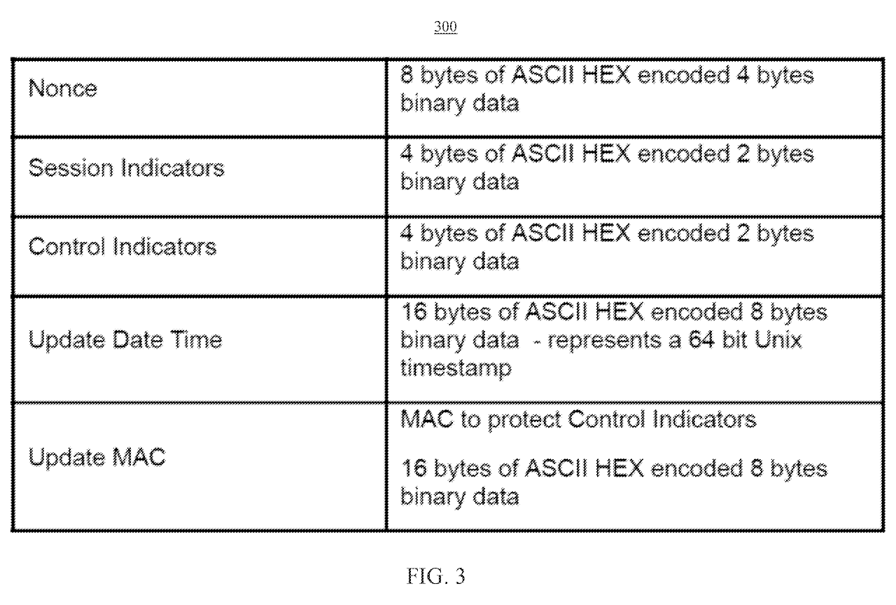

FIG. 3 illustrates a write command data packet encapsulated into an NDEF message for transmission to the contactless card applet. Control indicators may indicate a response format for returning the NDEF record during an NDEF read. Setting of the response format may be configured during the write of the nonce record. For example, a control indicators field may be included in the write command which can alter the configuration of the contactless card applet. The applet may update its internal setting upon successfully validating the Update MAC associated with the write command. The MAC may be calculated over the updated control indicators values and a timestamp included in the data, using a key that may be unique to the contactless card. In some embodiments, the timestamp may be treated as a counter value (e.g., used to verify that a provided value is greater than the last value seen by the applet). This ensures that the same update cannot be successfully replayed to the applet. The MAC process uses a key that is unique to the card. In some embodiments, session indicators provided in the NDEF convey to the contactless card applet whether the provided nonce is to be stored in non-volatile storage for use in subsequent NFC session write command. If the update MAC is correct updated value of Update Date Time is written to non-volatile memory and control indicators value are overwritten in the non-volatile memory to reflect the new values provided in the write command.

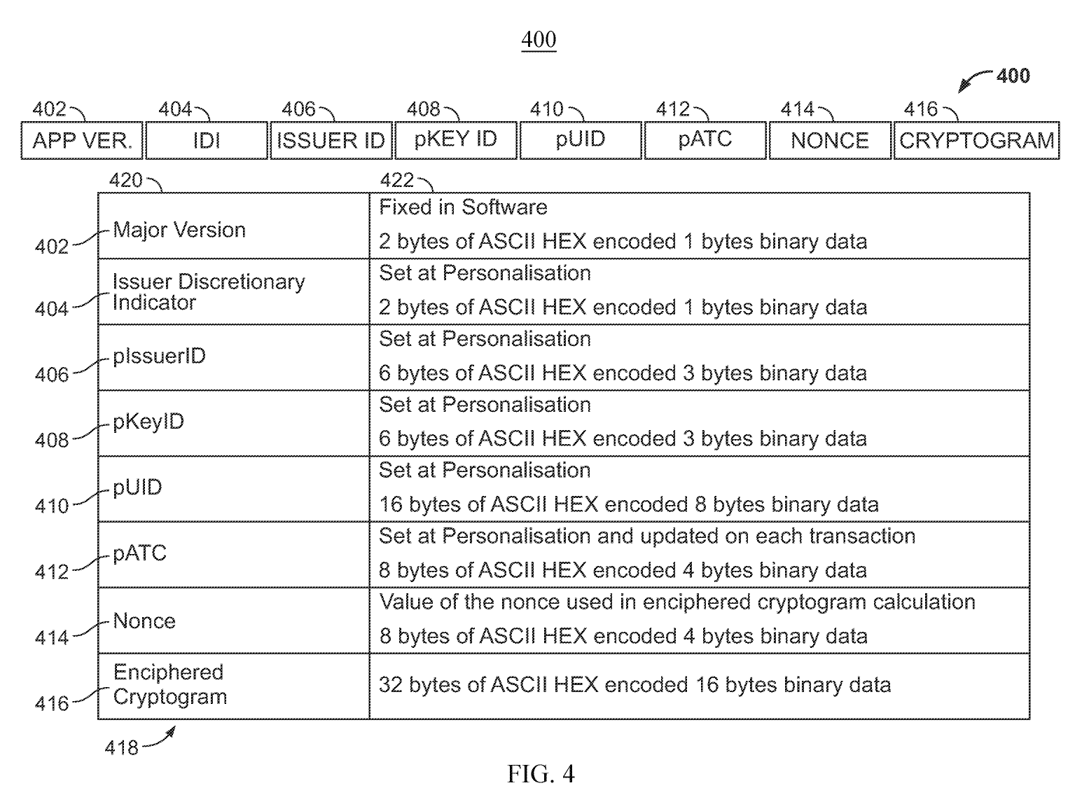

FIG. 4 illustrate an NDEF record generated by the contactless card applet in response to the NDEF write packet illustrated on FIG. 3. The Example NDEF read message 400 may be read by a device from a contactless card in accordance with the functions discussed herein. One or more of the fields in message 400 may also be utilized to perform authentication and/or validation techniques.

In some embodiments, the message 400 includes an applet version 402 field, an issuer discretionary indicator 404 field, an Issuer Identifier 406 field, a pKey ID 408 field, a pUID 410 field, a pATC 412 field, a nonce 414 field, and an encrypted cryptogram 416.

In some embodiments, the fields may be in plain text or encrypted. For example, the applet version 402 field may include an applet version in plain text. The applet version to indicate which applet version is installed on a contactless card and may be used by the other systems to determine how to process the message 400 when communicated. For example, different applet versions require different validation logic.

In some embodiments, the message 400 includes an issuer discretionary indicator 404 field that may include issuer data and set at the time of personalization. In addition, the message 400 includes an Issuer Identifier 406 field that may include a unique ID assigned to the entity issuing the card, e.g., the issuer. For example, each issuer may be assigned a unique identifier during an onboarding operation when joining the system.

In some embodiments, the message 400 includes a pKey ID 408 field. In some instances, the pKey ID 408 field may include data that identifies a set of master keys for a card issuer. The issuer’s set of master keys may utilize each cards set of derived master keys or unique derived keys (UDKs). Further, each card’s own set of master keys may be generated during the personalization of the card. The card’s UDKs may be utilized to generate session keys that are used to generate the application cryptogram. The session keys generated by a card may be regenerated by a system, e.g., the validator system, utilizing pKeyID to identify the issuer’s master keys to regenerate session keys by the system to perform a validation.

In some embodiments, each contactless card is given a unique 16-decimal digit identity (pUID) at the time of personalization. Derivation of the card applet’s unique keys using the pUID is performed off-card. The resultant application keys are injected during the personalization of the card. In embodiments, a card’s application eys are the same as the card’s derived master keys or UDKs.

The message 400 may include a pUID 410 field, including a card unique identifier assigned to the contactless card at personalization time. The pUID 410 field data may be a combination of alphanumeric characters used to uniquely identify each card and associated with a user.

In some embodiments, the message 400 includes a pATC 412 field configured to hold a counter value. The counter value keeps a count of reads (taps) made on the contactless card in a hexadecimal format in one example. Further, a counter value may be used to generate session keys to encrypt at least a portion of a message.

In some embodiments, each time a message 400 is created, a new session key is derived and utilized to generate one or more portions of the message 400. Specifically, a session key is used to calculate cryptographic data, which may include a message authentication code (MAC). The card's applet supports a session key derivation option to generate a unique cryptogram session key ASK.

In some embodiments, a portion of the data provided in message 400 is static and set on the card during the personalization of the card and other data is dynamic and may be generated by the card during an operation, e.g., when a read operation is being performed. Note that in some instances, the static information may be updateable, but may require the customer and card to go through a secure update process, which may be controlled by the issuer.

In some embodiments, the contactless card may communicate a message between a device, such as a mobile device, during a read operation. For example, in response to the contactless card being tapped onto a surface of the device, e.g., brought within wireless communication range, a read operation may be performed on the contactless card, and the contactless card may generate and provide the message to the device. For example, once within range, the contactless card and the device may perform one or more exchanges for the contactless card to send the message to the device.

The wireless communication may be in accordance with a wireless protocol, such as near-field communication (NFC), Bluetooth, WiFi, and the like. In some instances, a message may be communicated between a contactless card and a device via wired means, e.g., via the contact pad, and in accordance with the EMV protocol.

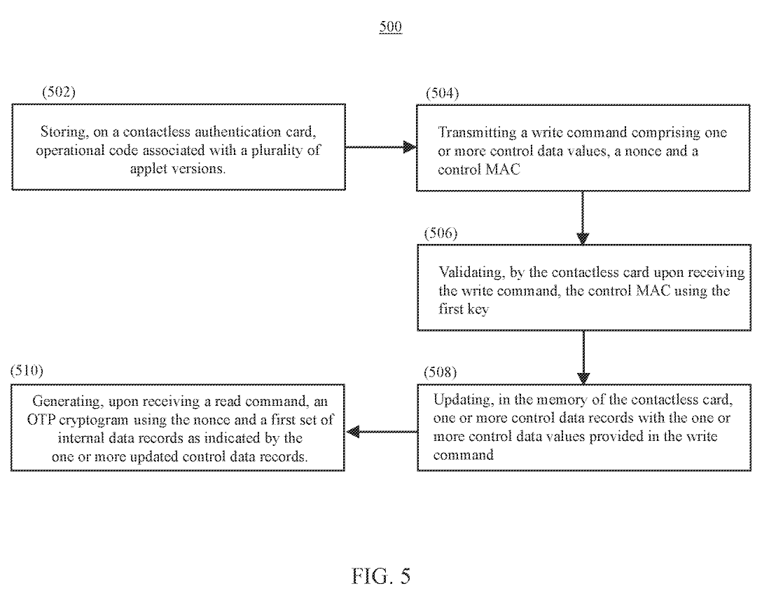

FIG. 5 illustrates an exemplary operational flow diagram 500 for secure mode switching of authentication protocol in a multi-mode applet stored on a contactless authentication card. Referring now to example process flow 500, step 502 may correspond to storing, on a contactless card, operational code associated with a plurality of applet versions, associated with a first applet stored on the contactless card. At step 504, a write command comprising one or more control data values for modifying values of control indicators associated with operation of the first applet is generated by a device communicatively coupled with the contactless card. The write command may further compromise a nonce value and a control/update MAC generated based on the nonce and the one or more control data values, using a first key unique to the contactless card. In some embodiments, the write command may be encapsulated into an NDEF message.

At step 506, the resulting NDEF data packet, comprising the write command for setting internal state of the card and the generated update MAC, may be transmitted to the contactless card, wherein the update MAC is validated by the contactless card using the first key. At step 508, upon validating the received update MAC associated with the write command, one or more control indicators in a memory of the contactless card are updated based on the one or more control bit values provided in the write command. The updating operation may further comprise writing the nonce in a volatile or non-volatile memory of the contactless card in accordance with the one or more control data values.

Step 510 corresponds to the response of the first applet to a read data command, received following the write data command and the updating operation initiated in response thereto. Accordingly at step 510 a response message, corresponding to an OTP cryptogram, is generated by the first applet by first applet using the nonce and a first set of data values internally stored on the contactless card. The nonce and the first set of data values are associated with the operations of the applet version as indicated and/or determined by the updated values of the one or more control indicators.

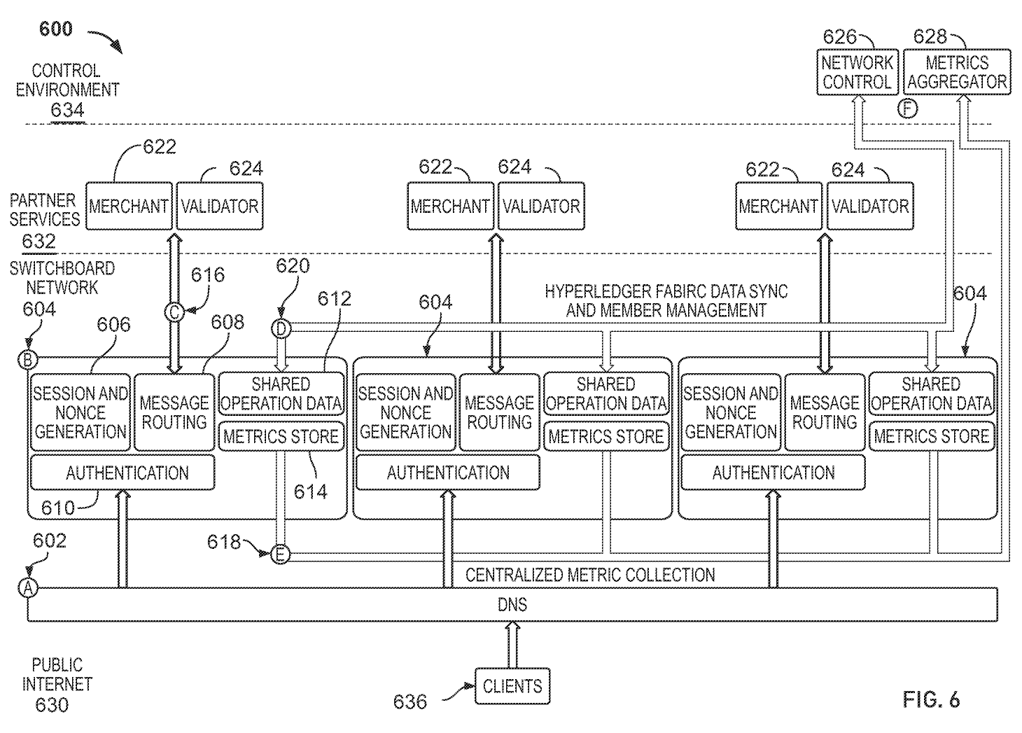

As described above, in accordance to some embodiments, the write command generation process may correspond to a server-side process wherein the server is communicatively coupled to the contactless card applet via the client device application having an NFC connectivity to the applet. Accordingly, one application of the described system and process may involve transmission of coded instructions (e.g., by a server-side process) to a distributed set of user mobile devices running a corresponding mobile application. The coded instructions may be generated as NDEF encapsulated data command for modifying internal settings of contactless card applets associated with a plurality of contactless card. As such, one operational aspect associated with the described system and method may correspond to server-initiated distributed writing of control and operational data onto a plurality of contactless card via corresponding plurality of mobile client devices. A exemplary implementation of the described distributed implementation may be performed by a switchboard system described in FIG. 6.

FIG. 6 illustrates an example of a switchboard-based system 600 in accordance with the embodiments discussed herein. The system 600 includes additional devices and systems configured to enable identity validation and other services to one or more client entities 636. Specifically, system 600 enables any number of issuer systems to provide identity validation and control services (e.g., issuing a distributed write command for altering a configuration of contactless card applets running on a plurality of contactless cards) to their clients through a switching fabric, i.e., the switchboard system in a secure and safe manner.

In some embodiments, the switchboard system includes one or more nodes 604 configured to perform routing operations. Each switchboard node 604 may include a session and nonce generator 606, a message router 608, an authentication function 610, an operation data 612 store, and a metrics store 614. Further, each of the nodes may be configured the same and share configurations, but each switchboard node 604 may independently process and route messages and requests to the appropriate systems. Each of the nodes 604 is configured to act as a broker of trust between an client device 636, merchant system 622, and/or validation system 624, for example. Each switchboard node 604 is configured to route each message to the correct issuer system while maintaining data security. For example, a switchboard node 604 may route a message between an issuer system and client device (e.g., using data fields such as the pUID 410 and pIssuerID 406) while the node is not able to gain access to the private data in the message.

The switchboard system may be configured as a server system including a collection of hardware, software, and networking components that work together to provide services to the clients. Hardware components may include one or more server computers, storage devices, and network adapters. The server computers are configured to run server applications, such as those executable on each of the nodes 604. In some instances, each of the server computers may be configured to operate one or more nodes, e.g., in a virtual environment. The storage devices are configured to store data that is accessed by the applications, and the network adapters are used to connect the server computer to the network.

Each of the server computers may be configured to execute software, including the operating system, the applications, and security software. The networking components of a server system include the network switch, router, and firewall. The network switch is used to connect the server computers to other devices on the network. The router is used to route traffic between different networks. The firewall is used to protect the server system from unauthorized access and attacks.

In some embodiments, the nodes 604 may operate in a cloud-based computing environment, e.g., a collection of hardware, software, and networking components that enable the delivery of cloud computing services. The switchboard nodes 604 and the computing services are delivered over the Internet, and they can be accessed from anywhere in the world with an Internet connection. In embodiments, a client 636 may access a switchboard node 604 through Domain Name System 602 or domain name system (DNS). The DNS 602 a hierarchical and distributed naming system for computers, services, and other resources connected to the Internet or other networks. It associates various information with domain names assigned to each registered participant. In one example, the DNS 602 may translate a name known to software executing on a client 636 to route data to one or more of switchboard node 604 of the switchboard system. In embodiments, the DNS 602 may generate into a number, such as an Internet Protocol (IP) address, an address record (A-record), or another Host name (C-name record). At a high level, the Domain Name System 602 translates known domain names to numerical Internet Protocol (IP) addresses needed for locating and identifying computer services and devices with the underlying network protocols.

In embodiments, a client 636 communicates with the switchboard system to perform one or more of the partner services 632. Once the client 636 identifies a switchboard node 604 and resolves an address to communicate with the switchboard node 604, the client 636 may send one or more messages to the switchboard node 604 to authenticate and perform one-or more operation. The switchboard node 604 includes an authentication 610 function that is configured to authenticate the client 636. In embodiments, the client 636 sends a message or authorization request to the switchboard node 604 based on a data frame format 400 illustrated in FIG. 4. Accordingly, one or more field in data frame 400 may be utilized to route the message 400 through the switchboard system. For example, different Applet versions require different validation logic, therefore Applet version field 402 may be used to appropriately route a message through the switchboard system to perform the various operations. Moreover, data fields such as the pUID 410 and pIssuerID 406 may be used to route a message between an issuer system and client device and vice versa.

The switchboard node 604 may authorize or authenticate the client 636 or user, and the switchboard node 604 may utilize the additional components, such as the session and nonce generator 206 and message router 208, to perform control operations associated, for example, with configuring an operation of a client device (e.g., contactless card). Note the clients 636 may never directly interact with the validator and/or merchant systems, nor vice versa. The nodes 204 brokers all communication.

In embodiments, the switchboard system may utilize a hyperledger fabric 620 to manage synchronizing the shared operation data 612 and member management across the network. The hyperledger fabric 620 is distributed ledger framework having a permissioned network model that only authorized participants can join the network and access the data that is stored on a ledger.

In embodiments, the hyperledger fabric 620 may be generated by creating one or more set of peers, an ordering service, and a channel. Once the network is created, the system 600 deploys chaincode to the network or nodes 604 permitted to access the fabric. The chaincode is the code that runs on the blockchain and executes the network control 626 and operation data 612 logic code. Once the chaincode is deployed, each of the switchboard nodes 604 is configured to invoke transactions on the blockchain to add data to the blockchain, e.g., the operational data. A switchboard node 604 or another device can query the ledger to retrieve data. The ledger is a distributed database that stores all of the data that has been added to the blockchain.

All nodes 604 keep an independently verifiable log of their actions that can be transmitted to a centralized aggregator to build a picture of overall network usage. At a central level, system 600 can manage network operation data and management and have a centralized view of network use, aggregated and abstracted to the appropriate level.

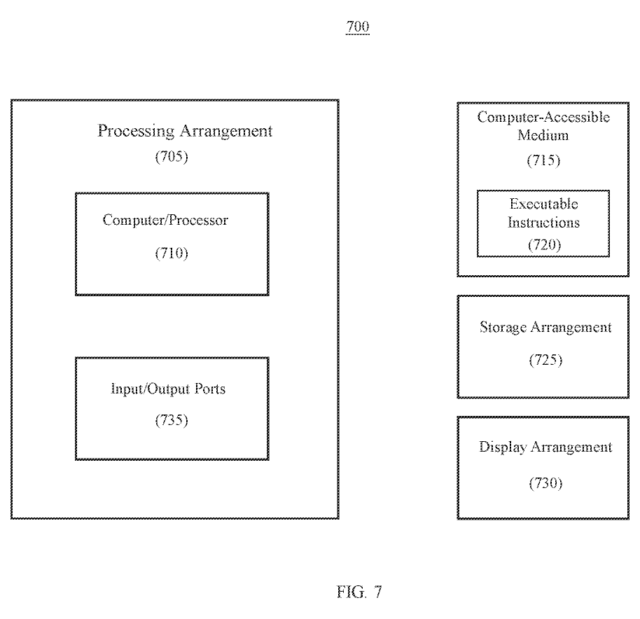

FIG. 7 shows a block diagram of an exemplary embodiment of a system according to the present disclosure. For example, exemplary procedures in accordance with the present disclosure described herein can be performed by a processing arrangement and/or a computing arrangement (e.g., computer hardware arrangement 705) may be configured for computing a trajectory of the contactless card within an optical field of view generated by a camera unit of user device and projecting a final placement of the contactless against a reader unit of the user device at a point at which the camera feed goes dark). Such processing and/or computing arrangement 705 can be, for example entirely or a part of, or include, but not limited to, a computer and/or processor 710 that can include, for example one or more microprocessors, and use instructions stored on a computer-accessible medium (e.g., RAM, ROM, hard drive, or other storage device).

As shown in FIG. 7, for example a computer-accessible medium 715 (e.g., as described herein above, a storage device such as a hard disk, floppy disk, memory stick, CD-ROM, RAM, ROM, etc., or a collection thereof) can be provided (e.g., in communication with the processing arrangement 705). The computer-accessible medium 715 can contain executable instructions 720 thereon. In addition or alternatively, a storage arrangement 725 can be provided separately from the computer-accessible medium 715, which can provide the instructions to the processing arrangement 705 so as to configure the processing arrangement to execute the exemplary procedures, processes, and methods, as described herein above, for example.

Further, the exemplary processing arrangement 705 can be provided with or include an input and/or output ports 735, which can include, for example a wired network, a wireless network, the internet, an intranet, a data collection probe, a sensor, etc. As shown in FIG. 7, the exemplary processing arrangement 705 can be in communication with an exemplary display arrangement 730, which, according to certain exemplary embodiments of the present disclosure, can be a touch-screen configured for inputting information to the processing arrangement in addition to outputting information from the processing arrangement, for example. Further, the exemplary display arrangement 730 and/or a storage arrangement 725 can be used to display and/or store data in a user-accessible format and/or user-readable format.

Systems and methods described herein can provide a system and configuration for performing an optimal NFC read of a contactless card by a reader device. Once a NFC link is established the wireless connectivity between the contactless card and the reader can permit, without limitation, financial transactions (e.g., credit card and debit card transactions), account management transactions (e.g., card refresh, card replacement, and new card addition transactions), membership transactions (e.g., joining and departing transactions), point of access transactions (e.g., building access and secure storage access transactions), transportation transactions (e.g., ticketing and boarding transactions), and other transactions.

In some aspects, the techniques described herein relate to a method of providing multi version application support on a contactless card, the method includes providing, on the contactless card storing a first applet associated with a first applet version, operational code associated with a plurality of applet versions, generating, by a first device in communication with the contactless card, a write data command includes one or more control data values, a nonce and a first message authentication code (MAC), the write command being transmitted to the first applet, updating, upon validation of the first MAC by the first applet, one or more control indicators in a memory of the contactless card based on the one or more control data values provided in the write command, where the one or more updated control indicators cause the first applet to operate in accordance with a second applet version, and in response to receiving a read data command, generating, by the first applet, a response message in accordance with the second applet version. The method may also include where the response message corresponds to a one-time password (OTP) cryptogram generated using the nonce and a first set of data records stored on the memory of the contactless card. The method may also include where the first MAC is generated, by the first device, using a first key. The method may also include the write data command is encapsulated into an NFC Data Exchange Format (NDEF) message prior to transmission to the first applet stored on the contactless card. The method may also include where the first device corresponds to a client communication device in near-field communication (NFC) connectivity to the contactless card. The method may also include where the write command and the read command are transmitted to the contactless card via distinct NFC sessions established between the contactless card and the client communication device. The method may also include where the first device corresponds to a server in network communication with a client device having an NFC connectivity to the contactless card. Other technical features may be readily apparent to one skilled in the art from the following figures, descriptions, and claims.

In some aspects, the techniques described herein relate to a system for enabling dynamic version switching on a multi-modal contact less card, the system includes A contactless card includes: A processor. The system also includes A memory storing a first applet associated with a first applet version, and operational code associated with a plurality of applet versions, and An NFC interface; and A client device in NFC connectivity with the contactless card, where the client deice is configured to generate a write data command includes one or more control data values for setting one or more control indicator values in the memory of the contactless card, and a first message authentication code (MAC), transmit the write data command and the first MAC, via the NFC interface, to the first applet stored on the contactless card, where upon receiving the write data command, the contactless card is configured to: Validate the first MAC, update, by the first applet, one or more control indicators values in the memory of the contactless card based on the one or more control data values provided in the write command, where the one or more updated control indicators cause the first applet to operate in accordance with a second applet version. The system may also include where, in response to receiving a read data command following the write command, the first applet is configured to generate a response message in accordance with the second applet version. Other technical features may be readily apparent to one skilled in the art from the following figures, descriptions, and claims.

In one aspect, the techniques described herein relate to a computer-readable non-transitory medium includes computer-executable instructions that, when executed by at least one processor, perform procedures includes the steps of providing, on the contactless card storing a first applet associated with a first applet version, operational code associated with a plurality of applet versions, generating, by a first device in communication with the contactless card, a write data command includes one or more control data values, a nonce and a first message authentication code (MAC), the write command being transmitted to the first applet, updating, upon validation of the first MAC by the first applet, one or more control indicators in a memory of the contactless card based on the one or more control data values provided in the write command, where the one or more updated control indicators cause the first applet to operate in accordance with a second applet version, and in response to receiving a read data command, generating, by the first applet, a response message in accordance with the second applet version. The method may also include , where the first set of data records, associated with operation of the first applet based on the second applet version, is a superset of a second set of data records associated with operation of the first applet based on the first applet version. The method may also include where the first MAC is computed on the nonce and the one or more control data values using the first key, and where the first MAC is validated by the first applet using the first key. The method may also include where the read data command is encapsulated into an NFC Data Exchange Format (NDEF) message prior to transmission to the first applet stored on the contactless card. The method may also include where the write command and the read command are performed within a same NFC session established between the contactless card and the client communication device. The method may also include where the nonce is written into a non-volatile memory of the contactless card based on a value of the one or more updated control indicators. The method may also include where the first device corresponds to a user computing device having a browser application with a WebNFC browser extension. The system may also include where the write data command and the read data command are transmitted, to the first applet of the contactless card, within a same NFC session established between the contactless card and the client device. The system may also include where the write command and the read command are transmitted to the contactless card via separate NFC sessions established between the contactless card and the client device. The system may also include where the response message corresponds to an OTP cryptogram generated based on a nonce data value, provided in the write data command, and a first set data internally stored in the memory of the contactless card, where the nonce data value is generated by the client device. The system may also include where the nonce is written into a non-volatile memory of the contactless card based on a value of the one or more updated control indicators. The system may also include where the first MAC is computed on the nonce and the one or more control data values using a first key, and where the first MAC is validated by the first applet using the first key. Other technical features may be readily apparent to one skilled in the art from the following figures, descriptions, and claims.

The present disclosure is not to be limited in terms of the particular embodiments described in this application, which are intended as illustrations of various aspects. Many modifications and variations can be made without departing from its spirit and scope, as may be apparent. Functionally equivalent methods and apparatuses within the scope of the disclosure, in addition to those enumerated herein, may be apparent from the foregoing representative descriptions. Such modifications and variations are intended to fall within the scope of the appended representative claims. The present disclosure is to be limited only by the terms of the appended representative claims, along with the full scope of equivalents to which such representative claims are entitled. It is also to be understood that the terminology used herein is for the purpose of describing particular embodiments only, and is not intended to be limiting.

As used herein, the term “card” is not limited to a particular type of card. Rather, it is understood that the term “card” can refer to a contact-based card, a contactless card, or any other card, unless otherwise indicated. It is further understood that the present disclosure is not limited to cards having a certain purpose (e.g., payment cards, gift cards, identification cards, membership cards, transportation cards, access cards), to cards associated with a particular type of account (e.g., a credit account, a debit account, a membership account), or to cards issued by a particular entity (e.g., a commercial entity, a financial institution, a government entity, a social club). Instead, it is understood that the present disclosure includes cards having any purpose, account association, or issuing entity.

The present disclosure includes example embodiments using NFC for contactless card communication, but it is understood that the present disclosure is not limited to a particular type of communication. Rather, the present disclosure encompasses other types of contactless card communication, such as Bluetooth, RFID, and Wi-Fi, along with NFC.

It is further noted that the systems and methods described herein may be tangibly embodied in one of more physical media, such as, but not limited to, a compact disc (CD), a digital versatile disc (DVD), a floppy disk, a hard drive, read only memory (ROM), random access memory (RAM), as well as other physical media capable of data storage. For example, data storage may include random access memory (RAM) and read only memory (ROM), which may be configured to access and store data and information and computer program instructions. Data storage may also include storage media or other suitable type of memory (e.g., such as, for example, RAM, ROM, programmable read-only memory (PROM), erasable programmable read-only memory (EPROM), electrically erasable programmable read-only memory (EEPROM), magnetic disks, optical disks, floppy disks, hard disks, removable cartridges, flash drives, any type of tangible and non-transitory storage medium), where the files that comprise an operating system, application programs including, for example, web browser application, email application and/or other applications, and data files may be stored. The data storage of the network-enabled computer systems may include electronic information, files, and documents stored in various ways, including, for example, a flat file, indexed file, hierarchical database, relational database, such as a database created and maintained with software from, for example, Oracle® Corporation, Microsoft® Excel file, Microsoft® Access file, a solid state storage device, which may include a flash array, a hybrid array, or a server-side product, enterprise storage, which may include online or cloud storage, or any other storage mechanism. Moreover, the figures illustrate various components (e.g., servers, computers, processors, etc.) separately. The functions described as being performed at various components may be performed at other components, and the various components may be combined or separated. Other modifications also may be made.

Computer readable program instructions described herein can be downloaded to respective computing and/or processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing and/or processing device receives computer readable program instructions from the network and forwards the computer readable program instructions for storage in a computer readable storage medium within the respective computing and/or processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, to perform aspects of the present invention.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions specified herein. These computer-readable program instructions may also be stored in a computer-readable storage medium that can direct a computer, a programmable data processing apparatus, and/or other devices to function in a manner, such that the computer readable storage medium having instructions stored therein comprises an article of manufacture including instructions which implement aspects of the functions specified herein.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions specified herein.

In the preceding specification, various embodiments have been described with references to the accompanying drawings. It will, however, be evident that various modifications and changes may be made thereto, and additional embodiments may be implemented, without departing from the broader scope of the invention as set forth in the claims that follow. The specification and drawings are accordingly to be regarded as an illustrative rather than restrictive sense.

1. A method of providing multi version application support on a contactless card, the method comprising:
providing, on the contactless card storing a first applet associated with a first applet version, operational code associated with a plurality of applet versions,
generating, by a first device in communication with the contactless card, a write data command comprising one or more control data values, a nonce and a first message authentication code (MAC), the write command being transmitted to the first applet;
updating, upon validation of the first MAC by the first applet, one or more control indicators in a memory of the contactless card based on the one or more control data values provided in the write command, wherein the one or more updated control indicators cause the first applet to operate in accordance with a second applet version; and
responsive to receiving a read data command, generating, by the first applet, a response
message in accordance with the second applet version.

2. The method of claim 1, wherein the response message corresponds to a one-time password (OTP) cryptogram generated using the nonce and a first set of data records stored on the memory of the contactless card.

3. The method of claim 2, wherein the first set of data records, associated with operation of the first applet based on the second applet version, is a superset of a second set of data records associated with operation of the first applet based on the first applet version.

4. The method of claim 1, wherein the first MAC is generated, by the first device, using a first key.

5. The method of claim 4, wherein the first MAC is computed on the nonce and the one or more control data values using the first key, and wherein the first MAC is validated by the first applet using the first key.

6. The method of claim 1, the write data command is encapsulated into an NFC Data Exchange Format (NDEF) message prior to transmission to the first applet stored on the contactless card.

7. The method of claim 6, wherein the read data command is encapsulated into the NDEF message prior to transmission to the first applet stored on the contactless card.

8. The method of claim 1, wherein the first device corresponds to a client communication device in near-field communication (NFC) connectivity to the contactless card.

9. The method of claim 8, wherein the write command and the read command are performed within a same NFC session established between the contactless card and the client communication device.

10. The method of claim 1, wherein the write command and the read command are transmitted to the contactless card via distinct NFC sessions established between the contactless card and the first device.

11. The method of claim 10, wherein the nonce is written into a non-volatile memory of the contactless card based on a value of the one or more updated control indicators.

12. The method of claim 10, wherein the first device corresponds to a user computing device having a browser application with a WebNFC browser extension.

13. The method of claim 1, wherein the first device corresponds to a server in network communication with a client device having an NFC connectivity to the first applet stored on the contactless card.

14. A system for enabling dynamic version switching on a multi-modal contact less card, the system comprising:
a contactless card comprising:
a processor, and a memory storing a first applet associated with a first applet version, and operational code associated with a plurality of applet versions;
an NFC interface; and
a client device in NFC connectivity with the contactless card,
wherein the client device is configured to:
generate a write data command comprising one or more control data values for setting one or more control indicator values in the memory of the contactless card, and a first message authentication code (MAC);
transmit the write data command and the first MAC, via the NFC interface, to the first applet stored on the contactless card;
wherein upon receiving the write data command, the contactless card is configured to:
validate the first MAC; and
update, by the first applet, one or more control indicators values in the memory of the contactless card based on the one or more control data values provided in the write command, wherein the one or more updated control indicators cause the first applet to operate in accordance with a second applet version.

15. The system of claim 14, wherein in response to receiving a read data command following the write command, the first applet is configured to generate a response message in accordance with the second applet version.

16. The system of claim 15, wherein the write data command and the read data command are transmitted, to the first applet of the contactless card, within a same NFC session established between the contactless card and the client device.

17. The system of claim 15, wherein the write command and the read command are transmitted to the contactless card via separate NFC sessions established between the contactless card and the client device.

18. The system of claim 15, wherein the response message corresponds to an OTP cryptogram generated based on a nonce data value, provided in the write data command, and a first set data internally stored in the memory of the contactless card, wherein the nonce data value is generated by the client device.

19. The system of claim 18, wherein the nonce is written into a non-volatile memory of the contactless card based on a value of the one or more updated control indicators.

20. The system of claim 18, wherein the first MAC is computed on the nonce and the one or more control data values using a first key, and wherein the first MAC is validated by the first applet using the first key.

21. A computer-readable non-transitory medium comprising computer-executable instructions that, when executed by at least one processor, perform procedures comprising the steps of:
providing, on a contactless card storing a first applet associated with a first applet version, operational code associated with a plurality of applet versions;
generating, by a first device in communication with the contactless card, a write data command comprising one or more control data values, a nonce and a first message authentication code (MAC), the write command being transmitted to the first applet;
updating, upon validation of the first MAC by the first applet, one or more control indicators in a memory of the contactless card based on the one or more control data values provided in the write command, wherein the one or more updated control indicators cause the first applet to operate in accordance with a second applet version; and
in response to receiving a read data command, generating, by the first applet, an output
message in accordance with the second applet version.
